(19) United States
(12) Patent Application Publication
(10) Pub. No.: US 2007/0246569 A1
(43) Pub. Date: Oct. 25, 2007

(54) Trigger Spray

(76) Inventor: Tetsuya Tada, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 11/547,989

(22) PCT Filed: Apr. 6, 2005
(86) PCT No.: PCT/JP05/06752

§ 371 Date: Jun. 15, 2007

(30) Foreign Application Priority Data
Apr. 6, 2004 (JP) 2004-112546

(51) Int. Cl. B05B 9/043

(52) U.S. Cl. 239/333

(57) ABSTRACT

To provide a trigger spray that can spray liquid on a target place reliably. A trigger spray 1 that moves a piston 9 utilizing a pressing force of a trigger portion to spray liquid in a cylinder from a nozzle portion 8, wherein a cylindrical barrel portion 3g is disposed along a container axial direction, a hinge portion 3c is formed at the barrel portion on the side of the nozzle portion thereof, the trigger portion is pivotally provided through the hinge portion, and the trigger portion is hung about the hinge portion toward the side opposite to the side of the nozzle portion at a reference position thereof. The trigger spray where an O-ring 6 is fitted between a mouth portion 2a of a container 2 and an outer cylinder portion formed so as to hang from a supporting wall portion 3e of the barrel portion 3g downwardly.

### TECHNICAL FIELD

The present invention relates to a trigger spray where a piston descends according to triggering.

In particular, the present invention relates to a trigger spray where a trigger is formed integrally with a cylindrical barrel portion disposed along a container axial direction through a hinge portion.

### BACKGROUND ART

Conventionally, as a trigger spray, one shown in FIG. 6 has been known (see Patent Literature 1).

A trigger spray 100 in the Patent Literature 1 has a container 101 filled with liquid and a cover portion 102 provided on the upper end side of the container 101.

One corner of the cover portion 102 is cut off largely, and a trigger portion 103 is exposed out of the cut portion.

When the ball of a thumb is put on an arc-shaped face of the trigger portion 103, and the trigger portion 103 is pushed in while a face on the side opposite to the side of a liquid spraying portion 104 is held by another finger(s), liquid is sprayed from around the liquid spraying portion 104.

Incidentally, the finger putting face of the trigger portion 103 is meshed to have a non-slip function.

Patent Literature 1: JP-A-2002-249155

### DISCLOSURE OF THE INVENTION PROBLEM TO BE SOLVED BY THE INVENTION

In the above-described trigger spray 100, however, when the trigger portion 103 is pushed in using a thumb, the base of the thumb (between the thumb and a forefinger) is opened, which makes it difficult to restrain the trigger spray 100 so as not to move by hand.

As a result, a force to grasp the trigger spray 100 becomes unstable, so that a nozzle portion moves when liquid is sprayed, which makes it impossible to conduct spraying on a predetermined place reliably.

The present invention is made on the basis of such a background art, and it is made for solving the above-described problem of the background art.

That is, an object of the present invention is to provide a trigger spray that can spray liquid on a target place reliably.

### MEANS FOR SOLVING THE PROBLEM

As a result of an accumulation of intensive studies with respect to such a background of the problem, the present inventor has found that the above-described problem can be solved by making it possible to push in a trigger portion on the side opposite to the side of a nozzle portion, and has achieved the present invention on the basis of the finding.

That is, the present invention lie in (1) a trigger spray that moves a piston utilizing a pressing force to a trigger portion to spray liquid in a cylinder from a nozzle portion, wherein a cylindrical barrel portion is disposed along a container axial direction, a hinge portion is formed at the barrel portion on the side of the nozzle portion thereof so that the trigger portion is pivotally provided through the hinge portion, and the trigger portion is hung about the hinge portion toward the side opposite to the side of the nozzle portion at a reference position thereof.

The present invention also lies in (2) the trigger spray according to the above (1), wherein the trigger portion is upwardly biased by a plate spring.

The present invention also lies in (3) the trigger spray according to the above (1), wherein a finger putting portion is formed on the trigger portion.

The present invention also lies in (4) the trigger spray according to the above (1), comprising a latch mechanism where a distal end of the trigger portion and a portion of the barrel portion are engaged with each other.

The present invention also lies in (5) the trigger spray according to the above (2), wherein the plate spring is disposed and fixed in an insertion space portion formed around an outer periphery of a guiding cylinder portion provided on a supporting wall portion of the barrel portion in a standing manner, and a insertion depth of the plate spring can be changed.

The present invention also lies in (6) the trigger spray according to the above (1), wherein a lower limit of movement of the plate spring is set by abutting of the plate spring on the supporting wall portion of the barrel portion.

The present invention also lies in (7) the trigger spray according to the above (5), wherein a vertical movement of the nozzle portion occurs vertically in a sliding manner inside the guiding cylinder portion through a slider portion of the nozzle portion provided radially in a projecting manner.

The present invention also lies in (8) the trigger spray according to the above (1), wherein an O-ring is fitted between a mouth portion of the container and an outer cylinder portion formed so as to hang from the supporting wall portion of the barrel portion downwardly.

A construction where some of the above (1) to (8) are combined properly can be employed as long as it attains the object of the present invention.

### ADVANTAGE OF THE INVENTION

According to the present invention, since the trigger portion is pivotally provided through the hinge portion on the cylindrical barrel portion disposed along a container axial direction, and the trigger portion is further hung about the hinge portion toward the side opposite to the side of the nozzle portion, when liquid in a cylinder is sprayed from the nozzle portion, liquid in the cylinder can be sprayed by putting the base of a thumb on the side of the nozzle portion and putting another finger on the trigger portion hanging on the side opposite to the nozzle portion to push in the trigger portion toward the side of the nozzle portion.

Therefore, when the trigger portion is pushed in using a forefinger, restriction of displacement of the trigger spray can be achieved reliably by the base of the thumb.

The trigger spray can be maintained in a stable state even if a force from the forefinger is applied thereto, so that the trigger spray itself can be prevented from being jiggled during spraying of liquid. Therefore, liquid can be sprayed on a target place reliably.

### BEST MODE FOR CARRYING OUT THE INVENTION

Best mode for carrying out the present invention will be explained below with reference to the drawings.

FIG. 1 shows a trigger spray according to an embodiment of the present invention.

The trigger spray 1 of the embodiment is a resin product, and it has a rectangular-parallelepiped-shaped container 2 within which liquid is enclosed and a cover portion 3 attached to the container 2 in a fitting manner.

The cover portion 3 is made slightly thinner than the container 2, where a small step is formed at a boundary between the cover portion 3 and the container 2.

This is because an overcap 3A becomes flush with the container 2, which does not cause any catching portion undulation therebetween, when the overcap 3A is fitted on the cover portion 3 (see a chain double-dashed line in FIG. 3).

Incidentally, it is preferable to use the overcap 3A for preventing operation when the trigger spray is carried for an over-the-counter sale.

A notched portion 3a cut off into an L-shape from an upper end of the cover portion 3 to a middle position thereof in a height direction is formed on the side face of the cover portion 3.

An elongate hole 3b is formed at a position corresponding to a nozzle 4 on the front face side of the cover portion 3 so as to make it possible to spray liquid from the nozzle 4 without any problem.

A hinge portion 3c is formed at one end of the cover portion 3 on the upper end side thereof corresponding to the upper side of the elongate hole 3b, and the trigger portion 3d is joined pivotally in a clockwise direction in FIG. 2 through the hinge portion 3c.

A finger putting portion 3d1 recessed in an arc shape is formed on the rear end side of the trigger portion 3d.

Since the finger putting portion 3d1 is provided, for example, it is easy to find a position to be put with a forefinger, and the finger is further put into a stable state.

Then, as shown in FIG. 2, when a user puts a finger on the finger putting portion 3d1 of the trigger portion 3d and pushes the finger in as it is, the trigger portion 3d enters the cover portion 3, so that a volume of the trigger portion exposed externally is reduced.

When the trigger portion 3d is pushed in to a position where the finger is caught on the notched portion 3a, pivoting of the trigger portion 3d is blocked.

Incidentally, as described later in FIG. 5, a distal end (a claw portion 3d3) of the trigger portion 3d abuts on a supporting wall portion 3e to stop the pivoting.

Before the trigger portion 3d is pushed in, the nozzle 4 is in a visible state on one side (the upper side) of the elongate hole 3b, and when the trigger 3d is pushed in at this time, a position of the nozzle 4 is gradually moved downwardly.

Then, when the trigger portion 3d is pushed in to a position shown in FIG. 2, the nozzle 4 reaches the other side (a lower side) of the elongate hole 3b.

When the trigger portion 3d is pushed in to the position shown in FIG. 2, the forefinger put on the finger putting portion 3d1 is brought into contact with a wall of the notched portion 3a, and the trigger portion 3d is not moved any more.

At such a point, the nozzle 4 is put into a visible state on one side (the lower side) of the elongate hole 3b.

Incidentally, in order to reliably prevent occurrence of such an event that some of liquid sprayed from the nozzle 4 hits on the inner wall of the cover portion 3, the elongate hole 3b may have an extra length.

FIG. 3 is a sectional view of the trigger spray 1.

A mouth portion 2a is formed at a position deviated from the central position of the container 2 on the upper end side of the container 2.

A pump assembly 5 assembled into a rod shape is inserted into the mouth portion 2a through a cylinder portion 3f as described later.

A notched portion 2b is formed in the outer peripheral face of the mouth portion 2a, and an O-ring 6 for ensuring sealing performance between the cover portion 3 and the cylinder portion 3f is fitted in the notched portion 2b.

The cover portion 3 has a cylindrical barrel portion 3g, and the supporting wall portion 3e is formed inside the cylindrical barrel portion 3g so as to run across the cylindrical barrel portion (in a horizontal direction).

The cylinder portion 3f is provided on the supporting wall portion 3c in a standing manner.

A claw portion 3g1 is formed at the lower end of the barrel portion 3g, and the cover portion 3 is reliably attached to the container 2 by engaging the claw portion 3g1 with a fitting portion 2c of the container 2.

The cylinder portion 3f has an inner cylinder portion 3f1 and an outer cylinder portion 3f2 which are formed so as to hang from the supporting wall portion 3e downwardly, and a guiding cylinder portion 3f3 is formed on the upper side of the supporting wall portion 3e.

The inner cylinder portion 3f1 is inserted into the mouth portion 2a of the container 2 so as to retain the pump assembly 5.

The outer cylinder portion 3f2 is fitted on the mouth portion 2a to catch the O-ring 6 therein and ensure airtightness, as described above.

Therefore, even if the container 2 is filled with volatile liquid, such a problem as transpiration does not occur.

An insertion space portion 3f4 is formed outside a guiding cylinder portion 3f3, and a rectangular plate spring 7 is disposed and fixed in the insertion space portion 3f4 by press fitting.

The plate spring 7 is preferably made from synthetic resin because the plate spring 7 should be an elastic body. A distal end of the plate spring 7 abuts on a gently-domed top plate portion 3d2 of the trigger portion 3d, more specifically, a state that the plate spring 7 is flexed into an arc shape while keeping an elastic force is maintained by the top plate portion 3d2.

A force required for pushing in the trigger portion 3d can be adjusted by adjusting a degree of flexure of the plate spring 7 and placing the same.

According to difference in user, for example, a man, a woman, a child or the like, a spring force of the elastic body can be increased or decreased.

The plate spring 7 is disposed and fixed (generally, fixed through press fitting) in the insertion space portion 3f4 in a flexed condition (curvature radius R1), for example as shown in FIG. 4(A), and when an elastic force of the plate spring 7 is required to be increased, flexure is increased (curvature radius R2) by reducing an insertion depth of the plate spring 7, as shown in FIG. 4(B) (R1>R2).

At this time, as shown in FIG. 4(B), a vector of a force biasing the trigger portion 3d faces in more vertical direction.

On the other hand, when an elastic force of the plate spring 7 is required to be decreased, flexure is reduced (curvature radius R3) by increasing an insertion depth of the plate spring 7, as shown in FIG. 4(C) (R3>R1).

At this time, as indicated by an arrow in FIG. 4(C), a vector of a force biasing the trigger portion 3d faces in more horizontal direction.

The claw portion 3d3 is formed on the distal end side of the trigger portion 3d so as to engage a part of an upper edge periphery of the barrel portion 3g, where so-called latch mechanism is formed.

Therefore, even if the trigger portion 3d returns to the original position after the trigger portion 3d is pulled, the distal end of the trigger portion 3d is caught at a part of the barrel portion 3g due to the latch mechanism, so that the trigger portion 3d is not moved excessively any more upwardly.

On the other hand, even if vibration is applied to a pump container itself, a rattle of the trigger portion 3d is prevented.

By the way, the upper end of the pump assembly 5 is engaged with the top board portion 3d2 with a small allowance, and when the trigger portion 3d is pulled, a position of the top plate portion 3d2 descends and a nozzle portion 8 of the pump assembly 5 joined with the top board portion 3d2 also descends.

The change of state will be explained in detail with reference to FIG. 5.

When the trigger portion 3d is pulled to cause the nozzle portion 8 to descend, a piston 9 joined to the lower end of the nozzle portion 8 also descends while sliding inside the guiding cylinder 10, so that a state shown in FIG. 5(A) is changed to a state shown in FIG. 5(B).

An F valve 12 is inserted into the guiding cylinder 10, and a space 11 between the F valve 12 and the piston 9 is compressed according to descending of the piston 9, so that liquid preliminarily present in the space 11 is sprayed from an end (the nozzle 4) of the nozzle head 8a through the piston 9 and the nozzle portion.

Then, the sprayed liquid passes through the elongate hole 3b of the cover portion 3 to be sprayed out.

In a state that the nozzle 4 descends, which is shown in FIG. 5(B), the plate spring 7 is largely flexed as compared with a state shown in FIG. 5(A), where a restoring force serving to restore the plate spring 7 to a flat plate shape is increased, and an internal energy stored in the plate spring is also increased.

In the plate spring 7, according to increase of a flexible volume, a force required for deforming the plate spring 7 is increased, so that a large pushing-in force of a forefinger is required.

Therefore, it is easy to stop the trigger portion 3d sensuously before the forefinger or the like abuts on the notched portion 3a when the trigger spray 1 is operated.

Incidentally, in case of this embodiment, when the finger putting portion 3d1 is pushed in to a position where the forefinger is put on the notched portion 3a, a flange portion 13a on a slider portion 13 radially provided from the nozzle portion 8 in a projecting manner abuts on the cylinder portion 3f (specifically, the guiding cylinder portion 3f3), so that the nozzle portion 8 and the piston 9 do not descend any more.

Here, the slider portion 13 slides inside the cylinder portion 3f (specifically, the guiding cylinder portion 3f3), which makes a vertical movement of the nozzle portion 8 in a stable state without swinging.

Incidentally, a point that the distal end (the claw portion 3d3) of the trigger portion 3d abuts on the supporting wall portion 3e to stop has been also described above.

When the forefinger is taken off in the state shown in FIG. 5(B) to release bias to the finger putting portion 3d1, the finger putting portion 3d1 is pushed back by a restoring force of the plate spring 7 to restore the state in the original position (namely, a reference position) shown in FIG. 5(A).

In the state shown in FIG. 5(A), though the plate spring 7 is still kept in an arc shape where it has been flexed, and the restoring force has not been cancelled completely, the distal end of the trigger portion 3d, namely, the claw portion 3d3 is caught at the upper end of the barrel portion 3g to be put into a resting state by the latch mechanism.

Incidentally, since the nozzle portion 8 is joined integrally with the top plate portion 3d2 of the trigger portion 3d, a position of the top plate portion 3d2 is forced to lift up by the plate spring 7 from the state shown in FIG. 5(B) to the state shown in FIG. 5(A) and the piston 9 also ascends, so that the space 11 recovers its volume in an initial state.

Incidentally, since the space 11 is put into a negative pressure state at this time, liquid in the container is sucked up through a guiding cylinder 10 to enter the space 11 and stored as liquid to be sprayed from the nozzle head 8a when the nozzle portion 8 is caused to descend at the next time.

In this manner, the trigger portion 3d and the nozzle portion 8 (joined integrally with the piston 9) are joined to each other, so that, when the trigger portion 3d is moved, the piston 9 is moved in a linkage manner.

Then, when pushing-in of the trigger portion 3d caused by a finger is released, the trigger portion 3d pivots about the hinge portion 3c upwardly due to a returning force of the plate spring 7 and the piston 9 ascends.

In this manner, by using the plate spring 7, pushing-in of the trigger portion 3d and releasing thereof can be repeated to reciprocate the piston 9.

Therefore, it is unnecessary to constitute such a complicated mechanism that a groove is formed in the piston 9 or the like and a C-ring is fitted in the groove, so that the piston 9 obtains a biasing force from a coil spring, which is conventionally required.

Additionally, a cost is also reduced.

In the trigger spray 1 of the above-described embodiment, since the trigger portion 3d is pivotally provided through the hinge portion 3c on the cylindrical barrel portion 3g disposed along a container axial direction, and the trigger portion 3d is further hung about the hinge portion 3c toward the side opposite to the side of the nozzle portion, when liquid in the cylinder is sprayed from the nozzle portion 8, liquid in the cylinder can be sprayed by putting a thumb on the side of the nozzle portion and putting another finger on the trigger portion 3d hanging on the side opposite to the nozzle portion 8 to push in the trigger portion 3d toward the side of the nozzle portion.

Therefore, a trigger spray 1 whose restriction can be reliably achieved mainly around the thumb exerting force to spray liquid on a target place reliably without occurrence of fluctuation or the like can be provided.

Though the present invention has been explained above, it is not limited to the above-described embodiment, and it is obvious that various modification can be made without departing from the scope of the present invention.

For example, undulation can be formed on a surface of the finger putting portion 3d1 to fulfill a non-slip function.

Though an example that the plate spring 7 is curved toward the side opposite to the side of the nozzle portion has been explained, the plate spring 7 may be curved toward the side of the nozzle portion by disposing the proximal end of the plate spring 7 on the side opposite to the nozzle portion.

### INDUSTRIAL APPLICABILITY

Though the present invention relates to a trigger spray where a trigger is formed integrally with a cylindrical barrel portion disposed along a container axial direction through a hinge portion, it can be applied to another spray of a container except for the present invention as long as utilizing the principle of the present invention.

### BRIEF DESCRIPTION OF THE DRAWINGS

FIG. 1 are explanatory views of a trigger spray according to an embodiment of the present invention.

FIG. 1(A) is a plan view, FIG. 1(B) is a front view, and FIG. 1(C) is a side view.

FIG. 2 is an explanatory view showing a state that a trigger portion of the trigger spray in FIG. 1 has been pushed in.

FIG. 3 is a half-sectioned view of the trigger spray in FIG. 1.

FIG. 4 are explanatory views showing a change in degree of flexure of a plate spring according to difference in insertion depth of the plate spring. Insertion length in an insertion hole of the plate spring increases in the order of FIGS. 4(B), FIG. 4(A), and FIG. 4(C).

FIG. 5 is an explanatory view showing a change in internal mechanism when liquid of the trigger spray in FIG. 1 is sprayed. (A) shows an initial state, namely, a state that the trigger portion has not been grasped yet, (B) shows a state that the trigger portion has been pushed in.

FIG. 6 is an explanatory view showing a trigger spray according to a conventional embodiment.

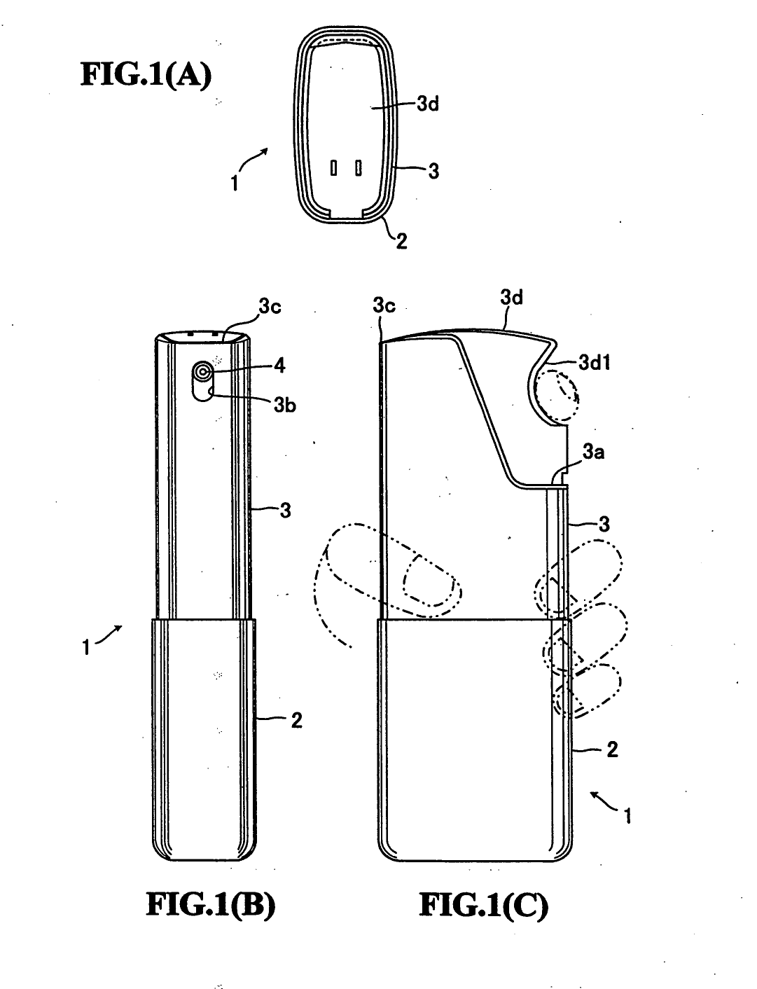

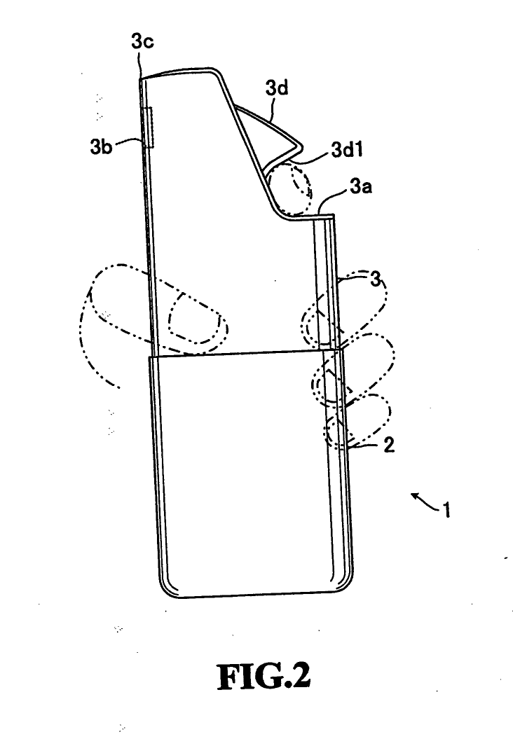

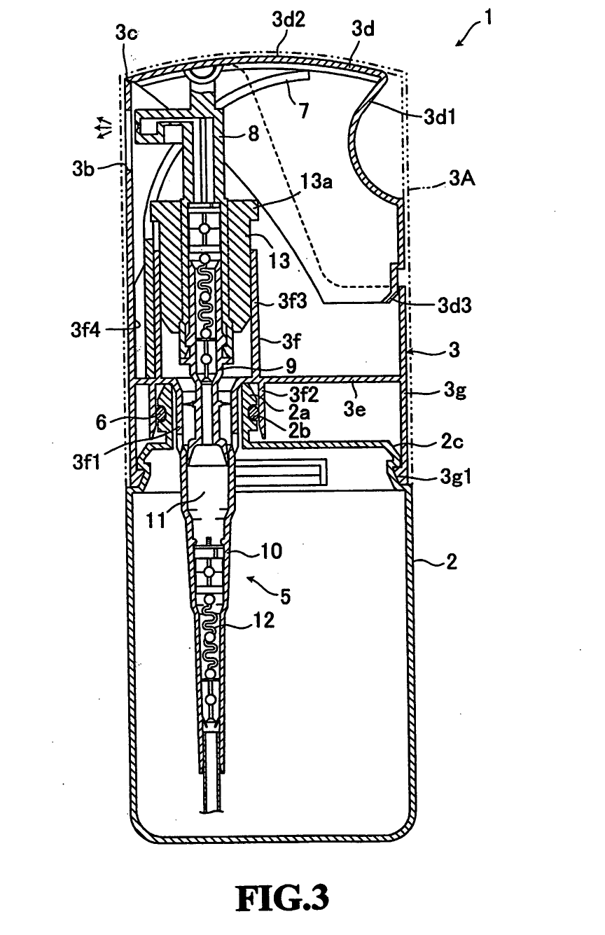

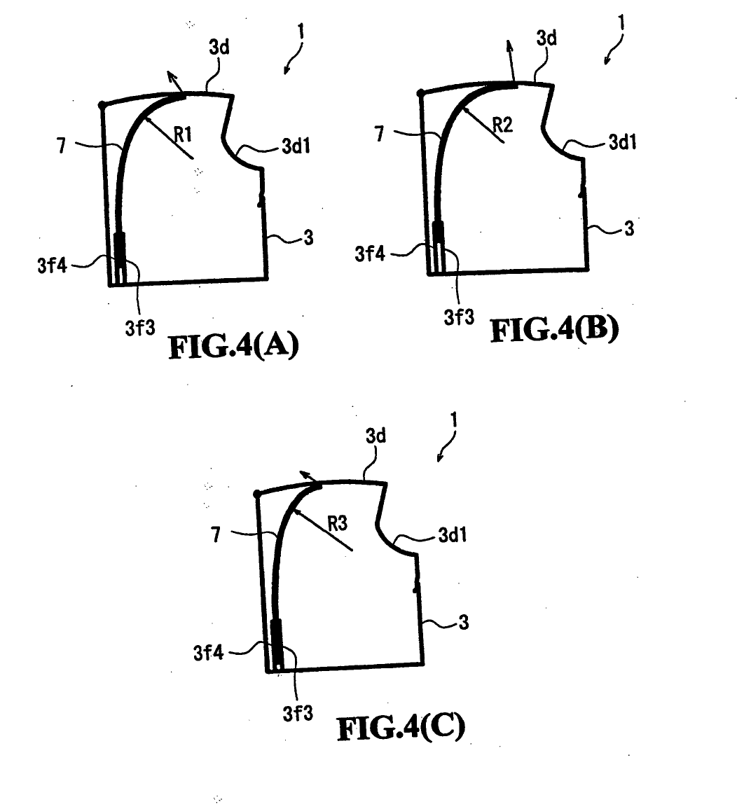

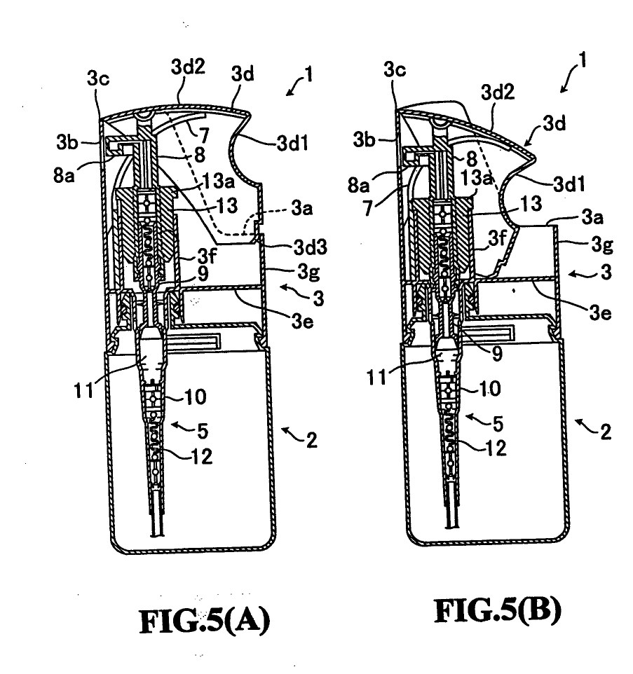

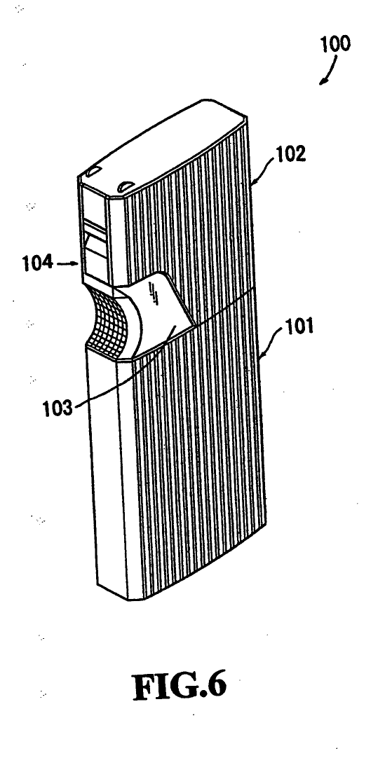

### EXPLANATION OF REFERENCE NUMERALS

1 trigger spray
2 container
2a mouth portion
2b notched portion
2c fitting portion
3 cover portion
3A overcap
3a notched portion
3b elongate hole
3c hinge portion
3d trigger portion
3d1 finger putting portion
3d2 top board portion
3d3 claw portion
3e supporting wall portion
3f cylinder portion
3f1 inner cylinder portion
3f2 outer cylinder portion
3f3 guiding cylinder portion
3f4 insertion space portion
3g barrel portion
3g1 claw portion
4 nozzle
5 pump assembly
6 O-ring
7 plate spring
8 nozzle portion
8a nozzle head
9 piston
10 guiding cylinder
11 space
12 F valve
13 slider portion
13a flange portion
100 trigger spray
101 container
102 cover portion
103 trigger portion
104 liquid spraying portion

What is claimed is:

1. A trigger spray that moves a piston utilizing a pressing force of a trigger portion to spray liquid in a cylinder from a nozzle portion, wherein
a cylindrical barrel portion is disposed along a container axial direction
a hinge portion is formed at the barrel portion on the side of the nozzle portion thereof, so that the trigger portion is pivotally provided through the hinge portion, and
the trigger portion is hung about the hinge portion toward the side opposite to the side of the nozzle portion at a reference position thereof.

2. The trigger spray according to claim 1, wherein the trigger portion is upwardly biased by a plate spring.

3. The trigger spray according to claim 1, wherein a finger putting portion is formed on the trigger portion.

4. The trigger spray according to claim 1, comprising a latch mechanism where a distal end of the trigger portion and a part of the barrel portion are engaged with each other.

5. The trigger spray according to claim 2, wherein the plate spring is disposed and fixed in an insertion space portion formed outside a guiding cylinder portion provided on a supporting wall portion of the barrel portion in a standing manner, and an insertion depth of the plate spring can be changed.

6. The trigger spray according to claim 1, wherein a lower limit of movement of the plate spring is set by abutting on the supporting wall portion of the barrel portion.

7. The trigger spray according to claim 5, wherein vertical movement of the nozzle portion occurs vertically in a sliding manner inside the guiding cylinder portion through a slider portion of the nozzle portion provided radially in a projecting manner.

8. The trigger spray according to the claim 1, wherein an O-ring is fitted between a mouth portion of the container and an outer cylinder portion formed so as to hang from the supporting wall portion of the barrel portion downwardly.
